(19) United States
(12) Patent Application Publication
(10) Pub. No.: US 2020/0184272 A1
(43) Pub. Date: Jun. 11, 2020

(54) FRAMEWORK FOR BUILDING AND SHARING MACHINE LEARNING COMPONENTS

(71) Applicant: ASTOUND AI, INC., Menlo Park, CA (US)

(72) Inventors: Zhenjie ZHANG, Fremont, CA (US); Karan SAMEL, Pleasanton, CA (US); Xu MIAO, Los Altos, CA (US); Maram NAGENDRAPRASAD, Menlo Park, CA (US); Ankit ARYA, San Jose, CA (US); Adil MOHAMMED, Hyderabad (IN); Baiji HE, Mountain View, CA (US); Masayo IIDA, Mountain View, CA (US)

(21) Appl. No.: 16/213,981

(22) Filed: Dec. 7, 2018

(51) Int. Cl. G06K 9/62; G06N 20/00

(52) U.S. Cl. CPC G06K 9/6262; G06K 9/6253; G06N 20/00

(57) ABSTRACT

One embodiment of the present invention sets forth a technique for managing machine learning. The technique includes organizing a set of reusable components for performing machine learning under a framework. The technique also includes representing, within the framework, a machine learning model as a graph-based structure that includes nodes representing a subset of the reusable components and edges representing input-output relationships between pairs of the nodes. The technique further includes validating the machine learning model based on inputs and outputs associated with the nodes and the input-output relationships represented by the edges in the graph-based structure. Finally, the technique includes generating the machine learning model according to the graph-based structure and configurations for the subset of the reusable components.

### BACKGROUND

### Field of the Various Embodiments

Embodiments of the present invention relate generally to machine learning, and more particularly, to frameworks for building and sharing components across machine learning models.

### Description of the Related Art

Machine learning may be used to discover trends, patterns, relationships, and/or other attributes related to large sets of complex, interconnected, and/or multidimensional data. To glean insights from large data sets, regression models, artificial neural networks, support vector machines, decision trees, naíve Bayes classifiers, and/or other types of machine learning models may be trained using input-output pairs in the data. In turn, the discovered information may be used to guide decisions and/or perform actions related to the data. For example, the output of a machine learning model may be used to guide marketing decisions, assess risk, detect fraud, predict behavior, and/or customize or optimize use of an application or website.

On the other hand, smaller organizations or entities may own data sets that are significantly smaller, noisier, mislabeled, and/or prone to fluctuation than those of larger organizations. In turn, machine learning models that are generated from the data sets using conventional supervised learning techniques may have higher bias, lower performance, less stability, and/or less accuracy than machine learning models that are created from larger, cleaner, and/or more stable data sets. At the same time, existing transfer learning techniques may lack enforcement of versioning in components of the machine learning models and/or require manual configuration of component sharing and/or optimization across machine learning models.

As the foregoing illustrates, what is needed is a more effective technique for adapting supervised learning techniques to small, dirty, noisy, and/or fluctuating data sets and/or streamlining transfer learning across machine learning models, data sets, and/or domains.

### SUMMARY

One embodiment of the present invention sets forth a technique for managing machine learning. The technique includes organizing a set of reusable components for performing machine learning under a framework. The technique also includes representing, within the framework, a machine learning model as a graph-based structure that includes nodes representing a subset of the reusable components and edges representing input-output relationships between pairs of the nodes. The technique further includes validating the machine learning model based on inputs and outputs associated with the nodes and the input-output relationships represented by the edges in the graph-based structure. Finally, the technique includes generating the machine learning model according to the graph-based structure and configurations for the subset of the reusable components.

At least one advantage and technological improvement of the disclosed techniques is reduced overhead and/or complexity associated with creating and improving machine learning models. Consequently, the disclosed techniques may provide technological improvements in the reusability and transferability of machine learning components, the creation of machine learning models from the components, and/or the performance of the machine learning models.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computing device configured to implement one or more aspects of the present disclosure;

FIG. 2 is a more detailed illustration of the framework of FIG. 1, according to various embodiments of the present invention;

FIG. 3 illustrates an example representation of a machine learning model within the framework of FIG. 1, according to various embodiments of the present invention;

FIG. 4 is a flow diagram of method steps for generating a machine learning model from reusable components, according to various embodiments of the present invention.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

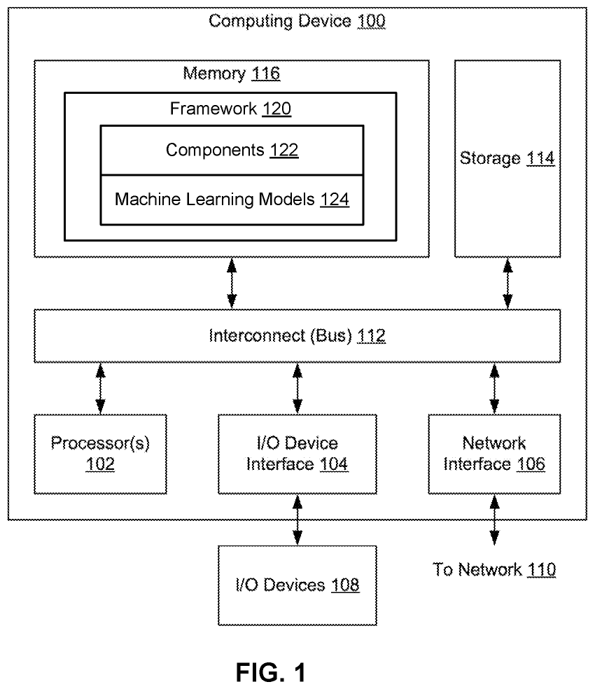

FIG. 1 illustrates a computing device 100 configured to implement one or more aspects of the present invention. Computing device 100 may be a desktop computer, a laptop computer, a smart phone, a personal digital assistant (PDA), tablet computer, or any other type of computing device configured to receive input, process data, and optionally display images, and is suitable for practicing one or more embodiments of the present invention. Computing device 100 is configured to run a framework 120 for performing machine learning that resides in a memory 116. It is noted that the computing device described herein is illustrative and that any other technically feasible configurations fall within the scope of the present invention.

As shown, computing device 100 includes, without limitation, an interconnect (bus) 112 that connects one or more processing units 102, an input/output (I/O) device interface 104 coupled to one or more input/output (I/O) devices 108, memory 116, a storage 114, and a network interface 106. Processing unit(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processing unit(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 may include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 may be any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 may include non-volatile storage for applications and data, and may include fixed or removable disk drives, flash memory devices, and CD-ROM, DVD-ROM, Blu-Ray, HD-DVD, or other magnetic, optical, or solid state storage devices. Framework 120 may be stored in storage 114 and loaded into memory 116 when executed. Additionally, one or more components 122 and/or machine learning models 124 may be stored in storage 114.

Memory 116 may include a random access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs, including a framework 120 for managing machine learning.

Framework 120 includes functionality to define and/or organize a set of components 122 that can be used and shared across multiple machine learning models 124. For example, machine learning models 124 may include artificial neural networks (ANNs), decision trees, support vector machines, regression models, naive Bayes classifiers, deep learning models, clustering techniques, Bayesian networks, hierarchical models, and/or ensemble models. Components 122 may include features and/or other inputs to machine learning models 124; modules that transform input data sets into output data sets and/or generate scores based on the input or output data sets; filters and/or conditions that are applied to the data sets; and/or other types of resources or functionality related to machine learning.

As discussed in further detail below, framework 120 may provide standardized schemas, interfaces, and/or mechanisms for defining components 122 and machine learning models 124 composed of interconnected components 122, validating machine learning models 124 based on input-output relationships between the corresponding components 122, generating variations of machine learning models 124, collecting performance metrics for the variations, and/or selecting one or more variations for deployment to a real-world environment based on the performance metrics. As a result, framework 120 may simplify or streamline the sharing and/or reuse of components 122 by multiple machine learning models 124, the creation of machine learning models 124 from predefined and/or configurable components 122, the customization of machine learning models 124 for different use cases and/or applications, and/or the maintenance, upgrading, and/or improvement of machine learning models 124.

### Framework for Building and Sharing Machine Learning Components

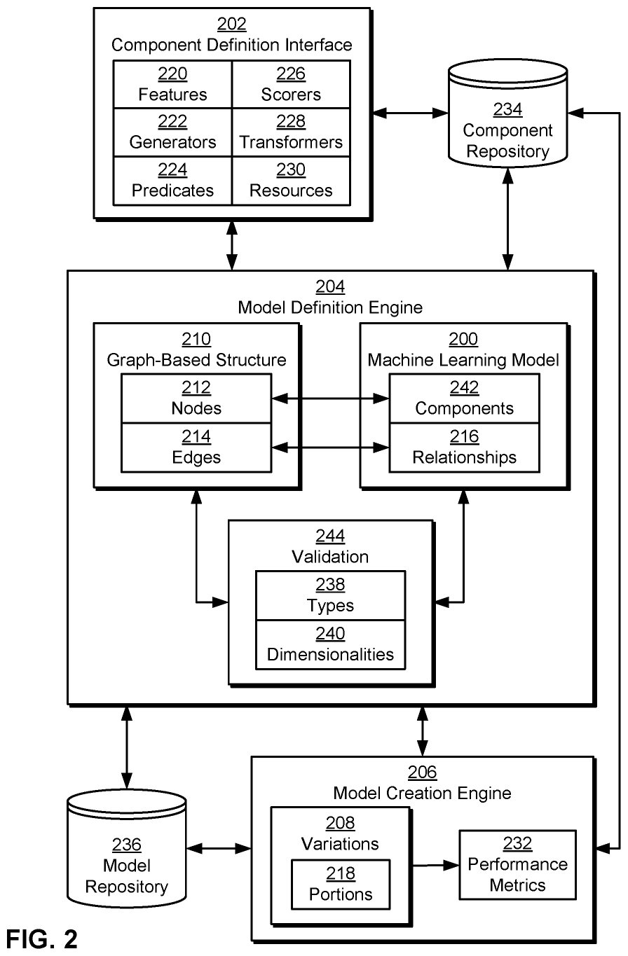

FIG. 2 is a more detailed illustration of framework 120 of FIG. 1, according to various embodiments of the present invention. As shown, framework 120 includes a component definition interface 202, a model definition engine 204, and a model creation engine 206. Each of these components is described in further detail below.

Component definition interface 202 may allow users to define and/or configure machine learning components 122 via a standardized schema and/or interface. For example, component definition interface 202 may include a graphical user interface (GUI), command-line interface (CLI), and/or other type of user interface that allows users to specify attributes and/or configuration options that are used to create components 122. In another example, component definition interface 202 may include functionality to create components 122 based on configurations that are defined using a domain-specific language (DSL) associated with framework 120.

In other words, component definition interface 202 may include functionality to obtain metadata, configuration options, and/or other attributes that are used to uniquely identify and/or create the corresponding components 122. For example, component definition interface 202 may obtain a name, version, description, and/or other metadata that identifies and/or describes a corresponding component. Component definition interface 202 may also, or instead, obtain a flag or setting specifying whether or not the component is “learnable” (i.e., if the component can be updated using machine learning and/or training techniques), one or more parameters that control the operation of the component, and/or one or more functions that initialize the component and/or apply the functionality of the component.

More specifically, component definition interface 202 may be used to create components 122 that include, but are not limited to, features 220, generators 222, predicates 224, scorers 226, transformers 228, and/or resources 230. Features 220 may represent components 122 that generate data for inputting into machine learning models 124. For example, features 220 may include values that are derived and/or extracted from records in databases, distributed filesystems, flat files, online services, search engines, and/or other types of data sources. In another example, features 220 may include tensors that are populated with real numbers, ranges of numeric values, and/or other numeric or vector representations of real-world data such as text, images, audio, video, locations, demographic attributes, and/or categories.

As a result, configuration options for features 220 may include data types (e.g., integers, floats, doubles, longs, Booleans, strings, categorical types, composite types, dates, identifiers, custom types, etc.), dimensions (e.g., 200 by 300), and/or tensor types (e.g., dense or sparse tensors) associated with tensors of values outputted by features 220. The configuration options may also, or instead, include functions and/or parameters that are used to initialize data sources associated with the features and/or transform raw input data into the corresponding tensors. Such data sources may include, but are not limited to, databases, distributed filesystems, search engines, caches, services, and/or other sources of data that is consumed by components 122. In turn, the functions and/or parameters may include names, paths, network locations, application programming interface (API) calls, and/or other information that can be used to request and/or retrieve data from the data sources.

Generators 222 may represent components 122 that generate human-readable output data from features 220 and/or other types of input data. For example, generators 222 may convert binary objects, tensors of numeric values, and/or other types of “raw” or input data into attribute-value pairs, database records, and/or other types of structured data. Configuration options for generators 222 may thus include schemas for the structured data and/or parameters or functions that are used to convert the input data into the structured data.

Predicates 224 may represent components 122 that apply filters and/or conditions to input data to produce output data. For example, predicates 224 may be used to apply filters containing numeric thresholds; ranges of numeric values or dates; blacklists and/or whitelists of categorical values, string values, and/or expressions; and/or other types of data to the input data. In turn, configuration options for predicates 224 may include parameters that define the thresholds, ranges, blacklists, and/or whitelists, as well as functions containing filtering logic that apply the parameters to the input data to produce the output data.

Scorers 226 may represent components 122 that generate scores and/or other numeric output of machine learning models 124. For example, scorers 226 may be used to generate numeric representations of probabilities, estimates, classifications, clusters, and/or other types of machine learning model output. In another example, scorers 226 may represent output layers of artificial neural networks and/or leaf nodes of decision trees. Configuration options for scorers 226 may include parameters and/or functions that implement the functionality of scorers 226.

Transformers 228 may represent components 122 that transform input data into output data for subsequent inputting into other components 122. For example, transformers 228 may include “learnable” components 122 that are used as hidden layers of artificial neural networks and/or deep learning models. As a result, transformers 228 may allow knowledge learned from a first data set and/or domain to be transferred to a second, related data set and/or domain without compromising the first data set. Configuration options for transformers 228 may include training techniques (e.g., gradient descent, stochastic gradient descent, batch gradient descent, etc.) and/or hyperparameters (e.g., machine learning model type, regularization parameter, convergence parameter, learning rate, step size, momentum, decay parameter, etc.) that are used to learn the corresponding machine learning model parameters.

After a component is defined and/or configured via component definition interface 202, the component is stored in a component repository 234 for subsequent retrieval and use. For example, a name, version, description, “learnable” setting, parameters, initialization function, application function, and/or other configuration options for each component may be stored in a separate configuration file and/or record for the component in a database, distributed filesystem, and/or other type of data store providing component repository 234.

Next, model definition engine 204 allows users to create machine learning models 124 from subsets of components 122 in component repository 234. More specifically, model definition 204 may obtain a graph-based structure 210 as a representation of a machine learning model 200. Like component definition interface 202, model definition engine 204 may allow one or more users to create graph-based structure 210 via a user interface and/or DSL associated with framework 120.

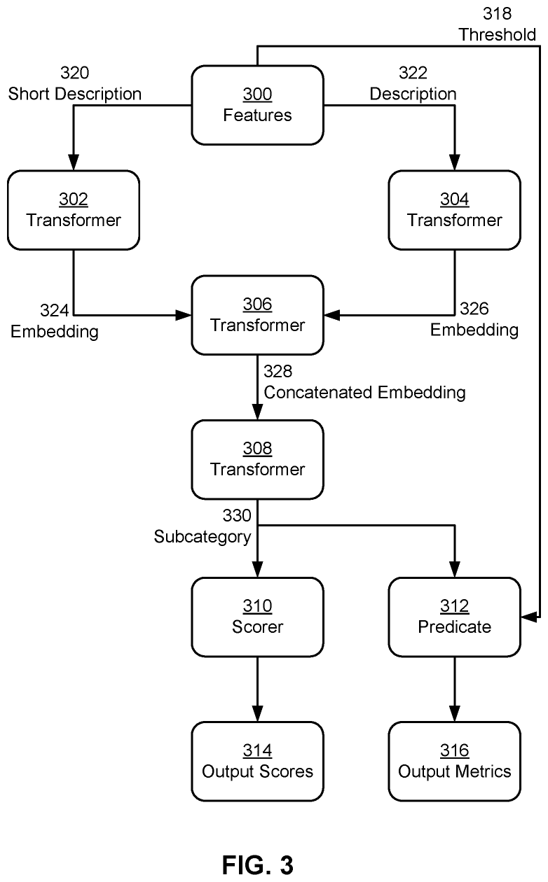

Graph-based structure 210 may include a directed acyclic graph (DAG) and/or another type of structure containing nodes 212 and edges 214 between pairs of nodes 212. Nodes 212 in graph-based structure 210 may represent components 242 that are selected to be in machine learning model 200, and edges 214 between nodes 212 may represent input-output relationships 216 between the corresponding components 242. For example, graph-based structure 210 may include nodes 212 representing one or more features 220, generators 222, predicates 224, scorers 226, transformers 228, resources 230, and/or other components 242 defined using component definition interface 202 and/or from component repository 234. Each node in graph-based structure 210 may be connected to at least one other node via a directed edge. The origin node of the directed edge may provide output data that is used as input data to the destination node of the directed edge. Graph-based structures in machine learning frameworks are described in further detail below with respect to FIG. 3.

To create machine learning model 200, a user may create a configuration containing a unique name, description, version, owner, and/or other metadata for machine learning model 200. The user may also add components 242 to machine learning model 200 by browsing and/or searching for components 242 within a user interface provided by model definition engine 204 and creating “bindings” of each component to machine learning model 200 within the configuration. Each binding may include the name of the corresponding component, the name of machine learning model 200, a variable name for each input to the component, and a variable name for each output of the component. The binding may also include options that identify the component as being used in training of the machine learning model and/or serving of the machine learning model in a real-world environment. The binding may further include runtime options such as caching, indexing, batch processing, and/or shrinking of output generated by the component.

To create an input-output relationship between two components in machine learning model 200, the user may use the same variable name as the output of one component and the input of the other component. In turn, model definition engine 204 may represent the input-output relationship as a directed edge between the corresponding nodes 212 in graph-based structure 210.

After machine learning model 200 is fully defined via graph-based structure 210, model definition engine 204 may perform validation 244 of machine learning model 200 using graph-based structure 210. First, model definition engine 204 may verify that each node is connected to at least one other node in graph-based structure 210. Model definition engine 204 may also, or instead, verify that nodes 212 that act only as inputs (e.g., nodes 212 representing features 220, resources 230, and/or other sources of input data) are able to produce the inputs using data sources and/or functions applied to the data sources specified in the corresponding configurations.

Second, model definition engine 204 may validate types 238 associated with components 242 and relationships 216 between components 242. For example, model definition engine 204 may verify that the output type (e.g., integer, long, double, float, Boolean, string, categorical type, composite type, date, identifier, custom type, etc.) of each component matches and/or is compatible with the input type of any other components connected to the component via directed edges 214 originating at the component.

Third, model definition engine 204 may validate dimensionalities 240 associated with components 242 and the corresponding relationships 216. For example, model definition engine 204 may verify that the dimensions of a tensor outputted by a first component are compatible with the dimensions of an input tensor for a second component that is connected to the first component via a directed edge originating at the first component.

After validation 244 of machine learning model 200 is complete, model definition engine 204 may store graph-based structure 210 in a model repository 236 for subsequent retrieval and use. For example, model definition engine 204 may store a configuration file, one or more records, and/or another representation of graph-based structure 210 in a relational database, graph database, distributed filesystem, and/or other data store providing model repository 236.

Model creation engine 206 may obtain graph-based structure 210 from model repository 236 and change one or more portions 218 of graph-based structure 210 to produce variations 208 of machine learning model 200. For example, model creation engine 206 may automatically generate variations 208 by changing the versions of one or more components 242 in machine learning model 200, adding and/or removing features or other inputs in machine learning model 200, adding and/or removing components 242 in machine learning model 200, and/or adjusting hyperparameters used to train machine learning model 200. In another example, model creation engine 206 may use a neural architecture search technique and/or another technique for generating or modifying the machine learning model architectures to generate variations 208 of machine learning model 200. In both examples, model creation engine 206 and/or model definition engine 204 may ensure that each variation of machine learning model 200 conforms to validation requirements associated with types 238, dimensionalities 240, and/or other attributes of components 242 in the variation.

Model creation engine 206 may also store graph-based representations of variations 208 in model repository 236. For example, model creation engine 206 may store a graph-based structure representing each variation of machine learning model 200 under the name of machine learning model 200 in model repository 236. To distinguish variations 208 from one another, model creation engine 206 may assign a unique version number to each variation and include the version number in a record representing the variation in model repository 236.

Model creation engine 206 may further create and/or execute variations 208 of machine learning model 200 according to the corresponding graph-based structures. For example, model creation engine 206 may retrieve parameters, call initialization functions, and/or perform other tasks to set up each variation of machine learning model 200. When training of the variation is required, model creation engine 206 may also input training data into the variation and use an optimization method to update the parameters (e.g., regression coefficients, neural network weights, etc.) of one or more trainable components 242 in the variation.

After machine learning model 200 and/or variations 208 are created, model creation engine 206 may evaluate performance metrics 232 from each variation of machine learning model 200. For example, model creation engine 206 may use a test and/or validation data set to evaluate the performances of multiple variations 208 of machine learning model 200 based on performance metrics 232 such as receiver operating characteristic (ROC) area under the curve (AUC), observed/expected (O/E) ratio, precision, recall, accuracy, and/or specificity.

Model creation engine 206 may then select a best-performing variation of machine learning model 200 for subsequent deployment in an environment. For example, model creation engine 206 may use performance metrics 232 to identify the best-performing variation and deploy the variation in an execution engine within a development, test, production, and/or other type of runtime environment. In another example, model creation engine 206 may output performance metrics 232 within a user interface, and a user may select a variation of machine learning model 200 and an environment in which to deploy the variation through the user interface.

Model creation engine 206 may additionally adjust the execution and/or use of machine learning model 200 based on performance metrics 232. In particular, performance metrics 232 may include a precision-coverage curve that reflects a tradeoff between the precision of machine learning model 200 and the coverage of machine learning model 200. The precision may be calculated as the number of true positives divided by the total number of positive predictions made by machine learning model 200, and the coverage may be calculated as the total number of positive predictions divided by the total number of predictions made by machine learning model 200.

In turn, model creation engine 206 may use the precision-coverage curve to select one or more operating thresholds for the output (e.g., scores, probabilities, etc.) of machine learning model 200. For example, machine learning model 200 may be used to identify articles and/or other content that can be recommended to users based on Information Technology (IT) service issues of the users. During initial ramping or use of machine learning model 200 in a production and/or other real-world environment, the operating threshold may be set to high precision and low coverage (e.g., 90% precision and 50% coverage), so that recommendations made based on the positive predictions are more likely to be accurate. Conversely, remaining issues that are not associated with the positive predictions may be handled through a manual workflow by human IT agents. After machine learning model 200 has been used for a certain period, the operating threshold ay be adjusted to lower the precision and increase the coverage (e.g., 80% precision and 80% coverage) to allow machine learning model 200 to generate more recommendations at a slight reduction in accuracy. At the same time, the increased familiarity of the human agents with the IT service issues and/or recommendations may allow the human agents to identify and discard false positives in the recommendations instead of forwarding the false positive recommendations to the users.

The operating threshold may additionally be customized to different use cases and/or types of issues. For example, the operating threshold may be adjusted for different categories of IT service issues, so that recommendations based on output of machine learning model 200 are high precision for one category and high coverage for another category.

Consequently, framework 120 may provide standardized interfaces and/or mechanisms for creating, maintaining, sharing, validating, and/or updating machine learning components and models. In contrast, conventional machine learning techniques may lack the ability to create and/or define reusable components that provide different types of machine learning functionality and can be shared across multiple models and/or domains. Instead, the conventional techniques may require the manual creation of each machine learning model using a separate set of source code, training of the machine learning model using a separate data set, and/or execution of the entire machine learning model within a restricted context (e.g., within a single organization and/or for a single use case).

FIG. 3 illustrates an example representation of a machine learning model within framework 120 of FIG. 1, according to various embodiments of the present invention. More specifically, FIG. 3 illustrates an example graph-based structure 210 of a machine learning model, such as machine learning model 200 of FIG. 2. As shown, the example graph-based structure 210 includes a set of nodes representing components in the machine learning model, as well as a set of edges representing input-output relationships between pairs of the nodes.

Nodes in the graph-based structure of FIG. 3 include representations of one or more data sources 300, multiple features 302-304, multiple transformers 306-308, a scorer 310, a predicate 312, a set of output scores 314, and a set of output metrics 316. Data sources 300 may provide raw data that is used with the machine learning model, features 302-304 may represent input to the machine learning model, transformers 306-308 may represent intermediate components and/or processing layers of the machine learning model, and scorer 310 and predicate 312 may represent components that generate output of the machine learning model.

Edges in the graph-based structure include input-output relationships representing a threshold 318, short description 320, description 322, two embeddings 324-326, a concatenated embedding 328, and a subcategory 330. An edge from data sources 300 to predicate 312 indicates that threshold 318 is outputted by data sources 300 and inputted into predicate 312. Another edge from data sources 300 to transformer 302 indicates that short description 320 is outputted by data sources 300 and inputted into feature 302. A third edge from data sources 300 to feature 304 indicates that description 322 is outputted by data sources 300 and inputted into feature 304. A fourth edge from feature 302 to transformer 306 indicates that embedding 324 is outputted by feature 302 and inputted into transformer 306. A fifth edge from feature 304 to transformer 306 indicates that embedding 326 is outputted by feature 304 and inputted into transformer 306. A sixth edge from transformer 306 to transformer 308 indicates that concatenated embedding 328 is outputted by transformer 306 and inputted into transformer 308. Two edges from transformer 308 to scorer 310 and predicate 312 indicate that subcategory 330 and/or other output of transformer 308 is inputted into scorer 310 and predicate 312. Finally, an edge between scorer 310 and output scores 314 indicates that output scores 314 are produced by scorer 310, and an edge between predicate 312 and output metrics 316 indicates that output metrics 316 are produced by predicate 312.

Consequently, the graph-based structure of FIG. 3 may be used to define a machine learning model that generates output scores 314 and output metrics 316 from input data that includes threshold 318, short description 320, and description 322. For example, features 302-304 may be used to create word embeddings 324-326 from text represented by short description 320 and description 322, respectively. Next, transformer 306 may merge embeddings 324-326 into a concatenated embedding 328 that is inputted into transformer 308, and transformer 308 may compute subcategory 330 from concatenated embedding 328. Subcategory 330 is inputted into scorer 310 to generate one or more output scores 314 associated with short description 320 and description 322, and subcategory 330 and threshold 318 are inputted into predicate 312 to generate output metrics 316 such as a number or proportion of output scores 314 and/or values of subcategory 330 that are greater than, less than, greater than or equal to, or less than or equal to threshold 318.

In turn, the graph-based structure may be used to enhance and/or perform enterprise process and/or service automation. For example, the graph-based structure may be used to generate output scores 314 that classify IT service tickets based on short description 320 and description 322 representation of the tickets. In turn, output scores 314 may be used to route the tickets to agents with experience in handling the types of incidents, requests, and/or issues described in the tickets. Output metrics 316 may include measures of similarity and/or compatibility between the tickets and a knowledge base of solutions for previous tickets and/or known issues. Thus, output metrics 316 that indicate high compatibility and/or a strong match between a ticket and a solution in the knowledge base may trigger recommendation of the solution for resolving the incident, request, and/or issue associated with the ticket.

Continuing with the above example, output scores 314 and/or output metrics 316 may be generated using reusable components that were created, trained, and/or updated using data from multiple data sets and/or domains. Such components may include features 302-304, transformers 306-308, scorer 310, and/or predicate 312. Parameters, functions, and/or other configuration options for the components may be created for use with one domain and/or data set (e.g., IT service tickets for one company) and reused with other domains and/or data sets (e.g., IT service tickets for another company) without compromising the confidentiality and/or security of the data sets.

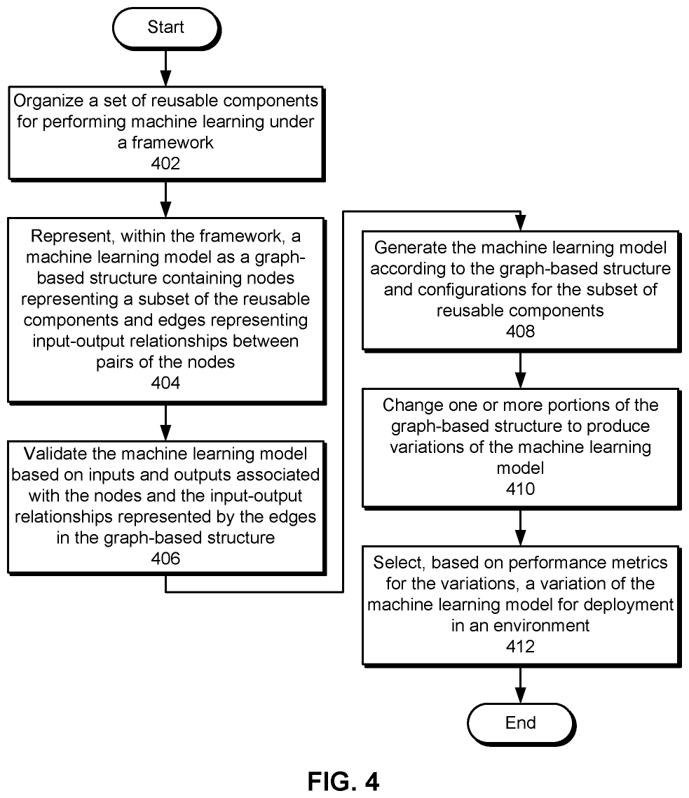

FIG. 4 is a flow diagram of method steps for generating a machine learning model from reusable components, according to various embodiments of the present invention. Although the method steps are described in conjunction with the systems of FIGS. 1-2, persons skilled in the art will understand that any system configured to perform the method steps, in any order, is within the scope of the present invention.

As shown, component definition interface 202 organizes 402 a set of reusable components for performing machine learning under a framework. For example, component definition interface 202 may obtain a configuration for each component via a user interface and/or DSL. The configuration may include a name, a version, a component type (e.g., feature, generator, transformer, predicate, scorer, resource, etc.), a learnable setting, one or more parameters, an initialization function that initializes the component, and/or an application function that applies or executes the functionality of the component. Component definition interface 202 may then store the configuration in a file, database record, and/or other persisted representation, thereby creating and/or maintaining a representation of the component based on the configuration. Component definition interface 202 may further provide functionality that allows users, applications, services, and/or other entities to search, browse, and/or retrieve components that are created, stored, and/or managed under the framework.

Next, model definition engine 204 represents 404, within the framework, a machine learning model as a graph-based structure containing nodes representing a subset of the reusable components and edges representing input-output relationships between pairs of the nodes. For example, each component in the machine learning model may be represented as a node in the graph-based structure. Each node may be connected to at least one other node in the graph-based structure via a directed edge. Each directed edge may represent the use of output from an origin node of the edge as input into a destination node of the edge.

Model definition engine 204 validates 406 the machine learning model based on inputs and outputs associated with the nodes and the input-output relationships represented by the edges in the graph-based structure. For example, model definition engine 204 may verify that a first dimensionality of an output of a first component is compatible with a second dimensionality of an input to a second component connected to the first component in the graph-based structure. Model definition engine 204 may also, or instead, verify that an output type of the first component matches an input type of the second component.

Model creation engine 206 then generates 408 the machine learning model according to the graph-based structure and configurations for the subset of reusable components in the machine learning model. For example, model definition engine 204 may retrieve parameters and/or call initialization functions in the component configurations. Model definition engine 204 may also update the parameters of trainable components in the machine learning model based on a set of training data, an optimization method, and/or one or more hyperparameters for the machine learning model.

Model creation engine 206 additionally changes 410 one or more portions of the graph-based structure to produce variations of the machine learning model. For example, model creation engine 206 may vary the machine learning model by adding and/or removing features and/or components in the graph-based structure, changing the version of a feature and/or component, and/or adjusting a hyperparameter for the machine learning model. Model creation engine 206 may also, or instead, use a neural architecture search technique and/or another technique for generating or modifying machine learning model architectures to generate one or more variations of the machine learning model.

Finally, model creation engine 206 selects 412, based on performance metrics for the variations, a variation of the machine learning model for deployment in an environment. For example, model creation engine 206 may collect the performance metrics by executing the variations on a test and/or validation data set. Model creation engine 206 may then select the best-performing variation for deployment in a development, testing, production, and/or other type of runtime environment. Alternatively, model creation engine 206 may output the performance metrics to a user, and the user may select a variation and/or an environment in which to deploy the variation based on the performance metrics. The deployed variation may then be executed to generate output for performing Information Technology (IT) service management and/or deriving other types of insights from input data to the machine learning model.

In sum, the disclosed techniques provide a framework that allows machine learning components to be built, shared, reused, and/or adapted across multiple machine learning models and/or domains. Within the framework, the machine learning models may be configured and/or defined using graph-based representations of the components. The framework may additionally use the graph-based representations to validate the machine learning models and/or generate variations of the machine learning models. Finally, the framework may select the best-performing variation of a given machine learning model for deployment in a real-world (e.g., development, test, production, etc.) environment or setting.

In turn, the disclosed techniques may reduce overhead and/or complexity associated with creating and improving machine learning models. More specifically, the disclosed techniques may provide standardized interfaces and/or mechanisms for creating, maintaining, sharing, validating, and/or updating machine learning components and models. Consequently, the disclosed techniques may provide technological improvements in the reusability and transferability of machine learning components, the creation of machine learning models from the components, and/or the performance of the machine learning models.

1. In some embodiments, a method for managing machine learning comprises organizing a set of reusable components for performing machine learning under a framework, wherein the set of reusable components comprises features inputted into one or more machine learning models, generators that produce human-readable output, predicates that apply conditions and filters, and scorers that rank output of the one or more machine learning models; representing, within the framework, a machine learning model included in the one or more machine learning models as a graph-based structure, wherein the graph-based structure comprises nodes representing a subset of the reusable components and edges representing input-output relationships between pairs of the nodes; validating the machine learning model based on inputs and outputs associated with the nodes and the input-output relationships represented by the edges in the graph-based structure; and generating the machine learning model according to the graph-based structure and configurations for the subset of the reusable components.

2. The method of clause 1, further comprising modifying one or more portions of the graph-based structure to produce variations of the machine learning model; and selecting, based on performance metrics for the variations, a variation of the machine learning model for deployment in an environment.

3. The method of clauses 1-2, wherein modifying the one or more portions of the graph-based structure comprises changing a component version of a reusable component in the graph-based structure.

4. The method of clauses 1-3, wherein modifying the one or more portions of the graph-based structure comprises at least one of adding a first feature to the graph-based structure; and removing a second feature from the graph-based structure.

5. The method of clauses 1-4, wherein modifying the one or more portions of the graph-based structure comprises adjusting a hyperparameter for the machine learning model.

6. The method of clauses 1-5, wherein modifying the one or more portions of the graph-based structure comprises at least one of adding a first component to the graph-based structure to produce a first variation of the machine learning model; and removing a second component from the graph-based structure to produce a second variation of the machine learning model.

7. The method of clauses 1-6, wherein the environment comprises at least one of a development environment, a testing environment, and a production environment.

8. The method of clauses 1-7, wherein organizing the set of reusable components for performing machine learning under the framework comprises receiving a configuration for a reusable component, wherein the configuration comprises at least one of a name, a version, a component type, a learnable setting, one or more parameters, an initialization function, and an application function; and creating the reusable component based on the configuration.

9. The method of clauses 1-8, wherein validating the graph-based structure based on the inputs and the outputs associated with the nodes and the edges in the graph-based structure comprises verifying that a first dimensionality of an output of a first component is compatible with a second dimensionality of an input to a second component connected to the first component in the graph-based structure.

10. The method of clauses 1-9, wherein validating the graph-based structure based on the inputs and the outputs associated with the nodes and the edges in the graph-based structure comprises verifying that an output type of a first component matches an input type of a second component connected to the first component in the graph-based structure.

11. The method of clauses 1-10, wherein the set of reusable components further comprises transformers that transform input data into output data.

12. The method of clauses 1-11, further comprising executing the machine learning model to generate output for performing Information Technology (IT) service management.

13. In some embodiments, a non-transitory computer readable medium stores instructions that, when executed by a processor, cause the processor to perform the steps of organizing a set of reusable components for performing machine learning under a framework, wherein the set of reusable components comprises features inputted into one or more machine learning models, generators that produce human-readable output, predicates that apply conditions and filters, and scorers that rank output of the one or more machine learning models; representing, within the framework, a machine learning model included in the one or more machine learning models as a graph-based structure, wherein the graph-based structure comprises nodes representing a subset of the reusable components and edges representing input-output relationships between pairs of the nodes; validating the machine learning model based on inputs and outputs associated with the nodes and the input-output relationships represented by the edges in the graph-based structure; and generating the machine learning model according to the graph-based structure and configurations for the subset of the reusable components.

14. The non-transitory computer readable medium of clause 13, wherein the steps further comprise modifying one or more portions of the graph-based structure to produce variations of the machine learning model; and selecting, based on performance metrics for the variations, a variation of the machine learning model for deployment in an environment.

15. The non-transitory computer readable medium of clauses 13-14, wherein changing the one or more portions of the graph-based structure comprises changing a component version of a reusable component in the graph-based structure.

16. The non-transitory computer readable medium of clauses 13-15, wherein changing the one or more portions of the graph-based structure comprises at least one of adding a first feature to the graph-based structure; and removing a second feature from the graph-based structure.

17. The non-transitory computer readable medium of clauses 13-16, wherein changing the one or more portions of the graph-based structure comprises at least one of adding a first component to the graph-based structure to produce a first variation of the machine learning model; and removing a second component from the graph-based structure to produce a second variation of the machine learning model.

18. The non-transitory computer readable medium of clauses 13-17, wherein organizing the set of reusable components for performing machine learning under the framework comprises receiving a configuration for a reusable component, wherein the configuration comprises at least one of a name, a version, a component type, a learnable setting, one or more parameters, an initialization function, and an application function; and creating the reusable component based on the configuration.

19. The non-transitory computer readable medium of clauses 13-18, wherein validating the graph-based structure based on the inputs and the outputs associated with the nodes and the edges in the graph-based structure comprises at least one of verifying that a first dimensionality of an output of a first component is compatible with a second dimensionality of an input to a second component connected to the first component in the graph-based structure; and verifying that an output type of the first component matches an input type of the second component.

20. In some embodiments, a system comprises a memory that stores instructions, and a processor that is coupled to the memory and, when executing the instructions, is configured to organize a set of reusable components for performing machine learning under a framework, wherein the set of reusable components comprises features inputted into one or more machine learning models, generators that produce human-readable output, predicates that apply conditions and filters, and scorers that rank output of the one or more machine learning models; represent, within the framework, a machine learning model included in the one or more machine learning models as a graph-based structure, wherein the graph-based structure comprises nodes representing a subset of the reusable components and edges representing input-output relationships between pairs of the nodes; validate the machine learning model based on inputs and outputs associated with the nodes and the input-output relationships represented by the edges in the graph-based structure; and generate the machine learning model according to the graph-based structure and configurations for the subset of the reusable components.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A method for managing machine learning, comprising:
organizing a set of reusable components for performing machine learning under a framework, wherein the set of reusable components comprises features inputted into one or more machine learning models, generators that produce human-readable output, predicates that apply at least one of conditions or filters, and scorers that generate numeric outputs, and wherein the set of reusable components is stored in a repository;
representing, within the framework, a machine learning model included in the one or more machine learning models as a graph-based structure, wherein the graph-based structure comprises nodes representing a subset of the reusable components and edges representing input-output relationships between pairs of the nodes;
validating the machine learning model based on inputs and outputs associated with the nodes and the input-output relationships represented by the edges in the graph-based structure;
retrieving the subset of reusable components represented by the nodes in the graph-based structure from the repository; and
generating the machine learning model using the subset of reusable components retrieved from the repository, wherein the machine learning model is generated according to the graph-based structure and configurations for the subset of the reusable components.

2. The method of claim 1, further comprising:
modifying one or more portions of the graph-based structure to produce variations of the machine learning model; and
selecting, based on performance metrics for the variations, one of the variations of the machine learning model for deployment in an environment.

3. The method of claim 2, wherein modifying the one or more portions of the graph-based structure comprises changing a component version of a reusable component in the graph-based structure.

4. The method of claim 2, wherein modifying the one or more portions of the graph-based structure comprises at least one of:
adding a first feature to the graph-based structure; or
removing a second feature from the graph-based structure.

5. The method of claim 2, wherein modifying the one or more portions of the graph-based structure comprises adjusting a hyperparameter for the machine learning model.

6. The method of claim 2, wherein modifying the one or more portions of the graph-based structure comprises at least one of:
adding a first component to the graph-based structure to produce a first variation of the machine learning model; or
removing a second component from the graph-based structure to produce a second variation of the machine learning model.

7. The method of claim 2, wherein the environment comprises at least one of a development environment, a testing environment, or a production environment.

8. The method of claim 1, wherein organizing the set of reusable components for performing machine learning under the framework comprises:
receiving a configuration for a reusable component, wherein the configuration comprises at least one of a name, a version, a component type, a learnable setting, one or more parameters, an initialization function, or an application function; and
creating the reusable component based on the configuration.

9. The method of claim 1, wherein validating the graph-based structure based on the inputs and the outputs associated with the nodes and the edges in the graph-based structure comprises verifying that a first dimensionality of an output of a first component is compatible with a second dimensionality of an input to a second component connected to the first component in the graph-based structure.

10. The method of claim 1, wherein validating the graph-based structure based on the inputs and the outputs associated with the nodes and the edges in the graph-based structure comprises verifying that an output type of a first component matches an input type of a second component connected to the first component in the graph-based structure.

11. The method of claim 1, wherein the set of reusable components further comprises transformers that transform input data into output data.

12. The method of claim 1, further comprising executing the machine learning model to generate output for performing Information Technology (IT) service management.

13. A non-transitory computer readable medium storing instructions that, when executed by a processor, cause the processor to perform the steps of:
organizing a set of reusable components for performing machine learning under a framework, wherein the set of reusable components comprises features inputted into one or more machine learning models, generators that produce human-readable output, predicates that apply at least one of conditions or filters, and scorers that generate numeric outputs, and wherein the set of reusable components is stored in a repository;
representing, within the framework, a machine learning model included in the one or more machine learning models as a graph-based structure, wherein the graph-based structure comprises nodes representing a subset of the reusable components and edges representing input-output relationships between pairs of the nodes;
validating the machine learning model based on inputs and outputs associated with the nodes and the input-output relationships represented by the edges in the graph-based structure;
retrieving the subset of reusable components represented by the nodes in the graph-based structure from the repository; and
generating the machine learning model using the subset of reusable components retrieved from the repository, wherein the machine learning model is generated according to the graph-based structure and configurations for the subset of the reusable components.

14. The non-transitory computer readable medium of claim 13, wherein the steps further comprise:
modifying one or more portions of the graph-based structure to produce variations of the machine learning model; and
selecting, based on performance metrics for the variations, one of the variations of the machine learning model for deployment in an environment.

15. The non-transitory computer readable medium of claim 14, wherein modifying the one or more portions of the graph-based structure comprises changing a component version of a reusable component in the graph-based structure.

16. The non-transitory computer readable medium of claim 14, wherein changing the one or more portions of the graph-based structure comprises at least one of:
adding a first feature to the graph-based structure; or
removing a second feature from the graph-based structure.

17. The non-transitory computer readable medium of claim 14, wherein changing the one or more portions of the graph-based structure comprises at least one of:
adding a first component to the graph-based structure to produce a first variation of the machine learning model; or
removing a second component from the graph-based structure to produce a second variation of the machine learning model.

18. The non-transitory computer readable medium of claim 13, wherein organizing the set of reusable components for performing machine learning under the framework comprises:
receiving a configuration for a reusable component, wherein the configuration comprises at least one of a name, a version, a component type, a learnable setting, one or more parameters, an initialization function, or an application function; and
creating the reusable component based on the configuration.

19. The non-transitory computer readable medium of claim 13, wherein validating the graph-based structure based on the inputs and the outputs associated with the nodes and the edges in the graph-based structure comprises at least one of:
verifying that a first dimensionality of an output of a first component is compatible with a second dimensionality of an input to a second component connected to the first component in the graph-based structure; or
verifying that an output type of the first component matches an input type of the second component.

20. A system, comprising:
a memory that stores instructions, and
a processor that is coupled to the memory and, when executing the instructions, is configured to:
organize a set of reusable components for performing machine learning under a framework, wherein the set of reusable components comprises features inputted into one or more machine learning models, generators that produce human-readable output, predicates that apply at least one of conditions or filters, and scorers that generate numeric outputs, and wherein the set of reusable components is stored in a repository,
represent, within the framework, a machine learning model included in the one or more machine learning models as a graph-based structure, wherein the graph-based structure comprises nodes representing a subset of the reusable components and edges representing input-output relationships between pairs of the nodes,
validate the machine learning model based on inputs and outputs associated with the nodes and the input-output relationships represented by the edges in the graph-based structure,
retrieve the subset of reusable components represented by the nodes in the graph-based structure from the repository, and
generate the machine learning model using the subset of reusable components retrieved from the repository, wherein the machine learning model is generated according to the graph-based structure and configurations for the subset of the reusable components.
